(19) United States
(12) Patent Application Publication
(10) Pub. No.: US 2025/0010750 A1
(43) Pub. Date: Jan. 9, 2025

(54) BATTERY EXCHANGE STATION-BASED FIRMWARE REPROGRAMMING SYSTEM AND FIRMWARE REPROGRAMMING METHOD USING SAME

(71) Applicant: Hyundai Kefico Corporation, Gunpo, Gyeonggi-Do (KR)

(72) Inventors: Sang Hoon Kim, Seoul (KR); Se Hee Byun, Seoul (KR); Hyeong Tae Noh, Gunpo, Gyeonggi-do (KR); Sil Lo Jin, Gunpo, Gyeonggi-do (KR); Dae Woo Kim, Gunpo, Gyeonggi-do (KR); In Jae Kwak, Hwaseong, Gyeonggi-do (KR); Nam Chul Paik, Anyang, Gyeonggi-do (KR); Ho Kyung Kim, Hwaseong, Gyeonggi-do (KR); Sang Hwan Oh, Hwaseong, Gyeonggi-do (KR)

(21) Appl. No.: 18/708,494

(22) PCT Filed: Oct. 27, 2022
(86) PCT No.: PCT/KR2022/016627

§ 371 Date: May 8, 2024

(30) Foreign Application Priority Data
Nov. 8, 2021 (KR) 10-2021-0152429

(51) Int. Cl. B60L 53/60; G06F 8/65

(52) U.S. Cl. CPC B60L 53/60; G06F 8/65; B60L 2270/00

(57) ABSTRACT

A system and method support automatic downloading and reprogramming of firmware utilizing a battery management system provided inside a battery pack in which a battery is mounted in a vehicle in an exchangeable manner. The system includes: a vehicle controller which communicates with a plurality of part controllers provided inside an electric vehicle so as to receive and store version information of firmware of each of the part controllers; the battery management system provided in the battery pack of the electric vehicle; a battery exchange station having a plurality of slots so as to charge the battery pack separated from the electric vehicle; and a server which transmits the firmware of each of the part controllers to the battery management system when the battery pack is inserted into a slot, where when the battery pack is mounted in the electric vehicle, firmware version information may be received and updated.

### BACKGROUND

### (a) Technical Field

The present disclosure relates to a battery exchange station-based firmware reprogramming system and a firmware reprogramming method, more particularly, to a system and method for supporting automatic downloading and reprogramming of the latest version of firmware by use of a battery management system provided inside a battery pack in an environment which is operated such that a battery is mounted in a vehicle in an exchangeable manner.

### (b) Description of the Related Art

Electric vehicles include controllers that control various types of parts, and the firmware of each controller can be updated (reprogrammed) to the latest version through CAN communication. There is a possibility that serious software defects may be found in vehicles after production and updates may be needed to correct such defects, and controllers may also improve various functions through updates. For these reasons, firmware reprogramming of electronic parts in vehicles is essential.

However, a separate dedicated device is required to reprogram each controller. Even when it is equipped with a reprogramming connector, OBD terminal, etc. as a separate dedicated device, only in the case where a separate reprogramming equipment (diagnostic device, CAN equipment, etc.) and a PC equipped with reprogramming software are installed, reprogramming is possible only through the corresponding equipment.

If the above equipment is not provided, a user must visit a professional after-sales service center to reprogram the firmware for each controller, and electric vehicle users are more likely to continue using a lower version of the controller rather than go through this hassle.

In addition, the above-mentioned reprogramming device must be mounted to be exposed to the outside of the vehicle in order to be connected to the reprogramming equipment, which acts as a constraint on vehicle layout design during the vehicle manufacturing stage.

Meanwhile, electric vehicles are eco-friendly vehicles and are gradually emerging as the mainstream vehicle technology, but there is an inconvenient problem because the time used to charge the battery is longer than the refueling time of an internal combustion engine vehicle. To solve this inconvenience, a battery exchange type operation station may be an alternative.

An exchange type operation station is a station operated by a method in which a charger with multiple slots is provided at the battery exchange station, and when a vehicle arrives at the station, the user inserts its discharged battery into an empty slot and withdraws the fully charged battery from the slot. This can shorten the time required to charge the battery.

### SUMMARY

An object of the present disclosure is to enable automatic reprogramming of a controller in an environment which is operated such that a battery is mounted in a vehicle in an exchangeable manner, without any separate devices or equipment for controller reprogramming, or without user action.

In order to achieve the above object, an embodiment of the present disclosure may comprise a vehicle controller which communicates with a plurality of part controllers provided inside an electric vehicle so as to receive and store version information of firmware of each of the part controllers; a battery management system provided in a battery pack of the electric vehicle; a battery exchange station including a plurality of slots so as to charge the battery pack separated from the electric vehicle; and a server which transmits the firmware of each of the part controllers to the battery management system when the battery pack is inserted into the slot, wherein when the battery pack is mounted in the electric vehicle, the battery management system may communicate with the vehicle controller to receive, store, and update version information of the firmware of each of the part controllers.

Here, when the battery pack is installed in the electric vehicle, the battery management system may compare first version information received from the vehicle controller with second version information downloaded and stored from the server.

Here, as a result of the comparison, if there is a controller to be reprogrammed in which the second version information is more recent than the first version information, among the plurality of part controllers and the vehicle controller, the battery management system may prohibit operation of the electric vehicle and reprogram the controller to be reprogrammed with firmware having the second version information.

Alternatively, in a possible embodiment, as a result of the comparison, if there is a controller to be reprogrammed in which the second version information is a more recent version than the first version information, among the plurality of part controllers and the vehicle controller, the battery management system may transmit reprogramming performance notification to a user of the electric vehicle.

In addition, after the reprogramming is completed, the battery management system may update the firmware version information of the controller to be reprogrammed to the vehicle controller and release the operation prohibition of the electric vehicle.

Meanwhile, as a result of the comparison, if there is a controller to be reprogrammed in which the first version information is a more recent version than the second version information, among the plurality of part controllers and the vehicle controller, the battery management system may store reprogramming error information and transmit the error information to the server after being mounted on the battery exchange station.

Alternatively, in a possible embodiment, as a result of the comparison, if there is a controller to be reprogrammed in which the first version information is a more recent version than the second version information, among the plurality of part controllers and the vehicle controller, the battery management system may receive and store the firmware of the controller, which is the latest version.

In addition, when the battery pack is mounted in the slot, the battery management system may compare the version information of the firmware of each of the part controllers being stored with the version information of the firmware stored in the server.

In this case, as a result of the comparison, if there is firmware in which the version information of the firmware stored in the server is more recent than the version information of the firmware of each of the part controllers, the battery management system may download and store the firmware stored in the server, and update the version information of the downloaded firmware.

Meanwhile, in a state in which the battery pack is mounted in the slot of the battery exchange station, if firmware whose version information has changed exists in the server, or if a preset period has elapsed, the battery management system may perform the comparison again.

In order to achieve the above object, an embodiment of the present disclosure is a battery exchange station-based firmware reprogramming method, and may comprise the steps of downloading, by a battery management system provided in a battery pack, the latest version of firmware stored in a server when the battery pack of an electric vehicle is mounted in a slot of the battery exchange station; and reprogramming, by the battery management system, firmware of a plurality of part controllers provided inside the electric vehicle or firmware of a vehicle controller when the battery pack that has completed charging at the battery exchange station is mounted on the electric vehicle, wherein in the step of reprogramming the firmware, when the battery pack is mounted in the electric vehicle, the battery management system may communicate with the vehicle controller to receive, store, and update version information of the firmware of each of the part controllers.

Here, in the step of reprogramming the firmware, when the battery pack is installed in the electric vehicle, first version information received from the vehicle controller is compared with second version information downloaded and stored from the server, wherein as a result of the comparison, if there is a controller to be reprogrammed in which the second version information is more recent than the first version information, among the plurality of part controllers and the vehicle controller, operation of the electric vehicle may be prohibited and the controller to be reprogrammed may be reprogrammed with firmware having the second version information.

Alternatively, in a possible embodiment, in the step of reprogramming the firmware, when the battery pack is installed in the electric vehicle, first version information received from the vehicle controller is compared with second version information downloaded and stored from the server, wherein, as a result of the comparison, if there is a controller to be reprogrammed in which the second version information is a more recent version than the first version information, among the plurality of part controllers and the vehicle controller, reprogramming performance notification may be transmitted to a user of the electric vehicle.

In addition, in the step of reprogramming the firmware, after the reprogramming is completed, the firmware version information of the controller to be reprogrammed may be updated to the vehicle controller and the operation prohibition of the electric vehicle may be released.

Meanwhile, in the step of reprogramming the firmware, when the battery pack is installed in the electric vehicle, first version information received from the vehicle controller is compared with second version information downloaded and stored from the server, wherein as a result of the comparison, if there is a controller to be reprogrammed in which the first version information is a more recent version than the second version information, among the plurality of part controllers and the vehicle controller, reprogramming error information may be stored and the error information may be transmitted to the server after being mounted on the battery exchange station.

Alternatively, in a possible embodiment, in the step of reprogramming the firmware, when the battery pack is installed in the electric vehicle, first version information received from the vehicle controller is compared with second version information downloaded and stored from the server, wherein as a result of the comparison, if there is a controller to be reprogrammed in which the first version information is a more recent version than the second version information, among the plurality of part controllers and the vehicle controller, the firmware of the controller, which is the latest version, may be transmitted and stored.

In the step of downloading the latest version of firmware, when the battery pack is mounted in the slot, the version information of the firmware of each of the part controllers being stored is compared with the version information of the firmware stored in the server, wherein as a result of the comparison, if there is firmware in which the version information of the firmware stored in the server is more recent than the version information of the firmware of each of the part controllers, the firmware stored in the server may be downloaded and stored, and the version information of the downloaded firmware may be updated.

In this case, in the step of downloading the latest version of firmware, in a state in which the battery pack is mounted in the slot of the battery exchange station, if firmware whose version information has changed exists in the server, or if a preset period has elapsed, the comparison may be performed again.

According to the present disclosure, through the battery management system provided in the battery pack, when the battery pack is mounted in the slot of the battery exchange station and being charged, the latest version of firmware is downloaded from the server, and when the charging of the battery pack is completed and the battery pack is mounted in the vehicle, it is configured to reprogram the firmware of the controllers of the vehicle equipped with the battery pack to the latest version. Therefore, automatic reprogramming of the controller is possible without any separate device, equipment, or user action.

As a result, first, the firmware of all vehicles using the battery exchange station can be maintained at the latest version, so vehicle recalls due to firmware can be prevented.

Second, the degree of freedom in layout when manufacturing a vehicle can be increased.

Further scope of applicability of the present disclosure will become apparent from the detailed description for implementing the disclosure below. It should be understood, however, that specific embodiments such as those included in the detailed description below for implementing the disclosure, are given by way of illustration only, since various changes and modifications within the spirit and scope of the disclosure will be apparent to those skilled in the art.

### BRIEF DESCRIPTION OF THE DRAWINGS

FIG. 1 shows a configuration of a battery exchange station-based firmware reprogramming system according to an embodiment of the present disclosure.

FIGS. 2A to 2D show the detailed configuration of each component in FIG. 1.

FIG. 3 is a flowchart showing a flow of a firmware reprogramming method according to an embodiment of the present disclosure.

FIG. 4 is a flowchart showing a detailed flow of a latest version firmware download step in FIG. 3.

FIG. 5 is a flowchart showing a detailed flow of a controller reprogramming step in FIG. 3.

FIG. 6 shows a detailed flow of a possible embodiment of a vehicle driving prohibition release step in FIG. 5.

FIG. 7 shows a detailed flow of another possible embodiment of a vehicle driving prohibition release step in FIG. 5.

### DETAILED DESCRIPTION

Hereinafter, an embodiment of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

In the description of the present disclosure, the terms such as first and second may be used to describe various components, but the components should not be limited by the terms. These terms are used only to distinguish one component from another component. For example, a first component may be named a second component, and similarly, the second component may also be named the first component, without departing from the scope of the present disclosure.

The term “and/or” may include a combinations of a plurality of the related and listed items or any item of a plurality of the related and listed items.

When one component is described as being “coupled” or “connected” to another component, it should be understood that one component can be coupled or connected directly to another component, and an intervening component can also be present between the components. When one component is described as being “coupled directly to” or “connected directly to” another component, it should be understood that no intervening component is present between the components.

The terms used herein is used for the purpose of describing particular embodiments only and is not intended to limit the present disclosure. Singular expressions may include plural expressions unless clearly described as different meanings in the context.

In the specification, it will be further understood that the terms “comprise” and “include” specify the presence of stated features, integers, steps, operations, elements, components, and/or combinations thereof, but do not preclude in advance the possibility of the presence or addition of one or more other features, integers, steps, operations, elements, components, and/or combinations.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

Further, the following embodiments are provided to more completely explain the present disclosure to those skilled in the art, and shapes and sizes of elements illustrated in the drawings may be exaggerated for a more apparent description.

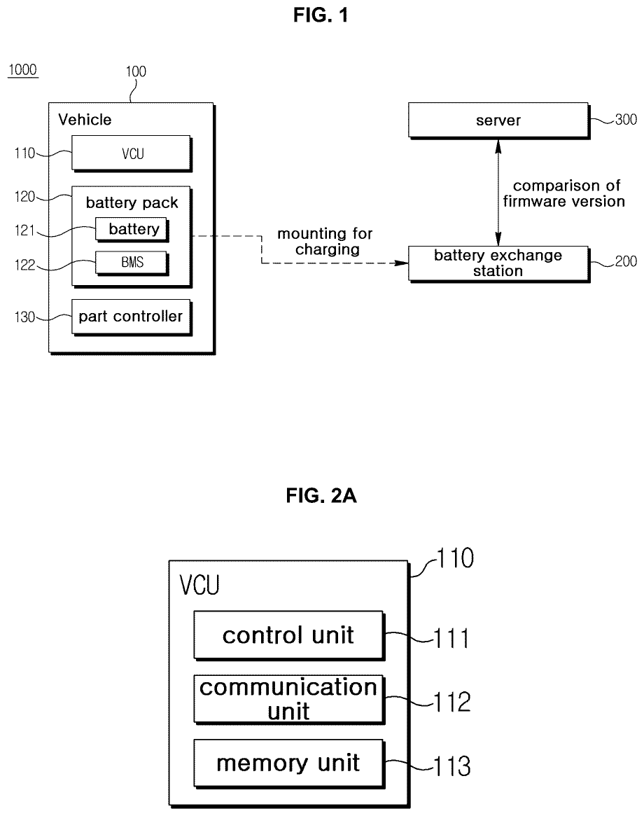

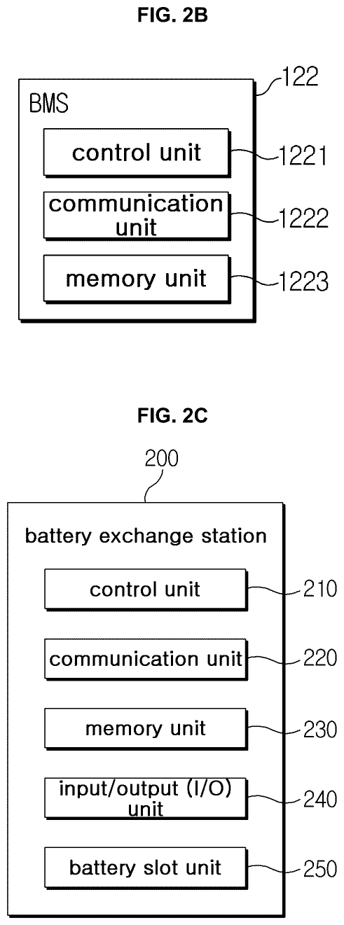

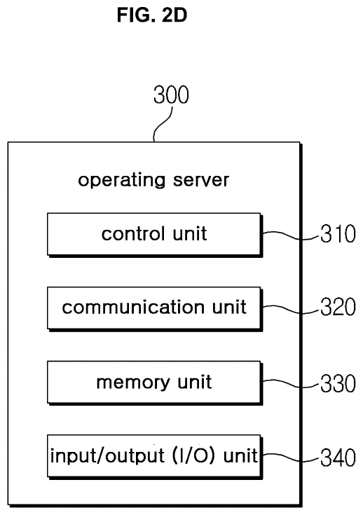

FIG. 1 shows a configuration of a battery exchange station-based firmware reprogramming system according to an embodiment of the present disclosure. FIGS. 2A to 2D show the detailed configuration of each component in FIG. 1.

With reference to FIGS. 1 and 2A to 2D, a battery exchange station based firmware reprogramming system 1000 according to an embodiment of the present disclosure (hereinafter referred to as a firmware reprogramming system) may include a vehicle 100, a battery exchange station 200, and a server 300.

The vehicle 100 is an electric vehicle driven using power supplied from a battery pack 120 mounted on the vehicle 100, and may be, for example, an electric two-wheeled vehicle.

The vehicle 100 may include a vehicle controller (vehicle control unit (VCU)) 110, a battery pack 120, and a plurality of part controllers 130.

The vehicle controller 110 may include a communication unit 112.

The vehicle controller 110 communicates with the plurality of part controllers 130 provided inside the vehicle 100 through a communication unit 112 to receive and store version information of the firmware of each of the part controllers 130.

In this case, the part controller 130 is a controller that controls various electronic parts mounted on the vehicle 100, and may correspond to, for example, a motor controller that controls motor operation, an instrument panel controller that controls the operation of the instrument panel, an air conditioning controller that controls the operation of an air conditioning system, etc.

The vehicle controller 110 may communicate with the battery pack 120 through the communication unit 112 and transmit the version information of the firmware of each of the part controllers 130 stored by the vehicle controller to a battery management system (BMS) 122.

Meanwhile, the communication may be CAN communication, for example.

The vehicle controller 110 may further include a control unit 111. The control unit 111 may be any of various controllers that can perform operations by executing computer program instructions, such as a CPU, MCU, microcontroller, or microprocessor.

The control unit 111 may control each component of the vehicle controller 110. For example, the control unit 111 may function as a communication module together with the communication unit 112 to control transmission and reception of information between the battery pack 120 and the plurality of part controllers 130.

Alternatively, for example, the control unit 111 may function as a memory module together with a memory unit 113 and control to load data stored in the memory unit 113 or store new data. The memory unit 113 may include volatile memory and non-volatile memory. For example, it may be at least one of various storage media such as semiconductor memory such as RAM, ROM, and flash memory, magnetic disk, and optical disk. The memory unit 113 may be built into the control unit 111 or may be installed separately from the control unit 111. The memory unit 113 may store firmware version information received from each of the plurality of part controllers 130.

The battery pack 120 may include a battery 121 and a battery management system (BMS) 122.

The battery 121 may have a structure in which multiple battery cells are composed of series, parallel, or a combination of series and parallel, multiple battery cells are gathered to form a battery module, and multiple battery modules are gathered to form a battery pack.

The BMS 122 is provided inside the battery pack 120 and is a type of controller that monitors the voltage, current, and temperature of the battery pack 120 to maintain the battery pack in an optimal state. It pays an important role in battery management, such as predicting battery replacement times and detecting battery problems in advance.

More specifically, the battery management system 122 may include a control unit 1221, a communication unit 1222, and a memory unit 1223.

The control unit 1221 may be any of various controllers that may perform operations by executing computer program instructions, such as a CPU, MCU, microcontroller, or microprocessor.

The control unit 1221 may control each component of the BMS 122. For example, the control unit 1221 may function as a communication module together with the communication unit 1222 to control transmission and reception of information between the vehicle controller 110 and the server 300. In an embodiment of the present disclosure, the control unit 1221 may reprogram the firmware of the part controllers 130.

Alternatively, for example, the control unit 1221 may function as a memory module together with the memory unit 1223 and control the memory unit 1223 to load data stored in the memory unit 1223 or to store new data. The memory unit 1223 may include volatile memory and non-volatile memory. For example, it may be at least one of various storage media such as semiconductor memory such as RAM, ROM, and flash memory, magnetic disk, and optical disk. The memory unit 1223 may be built into the control unit 1221 or may be installed separately from the control unit 1221. The memory unit 1223 may store firmware version information received from the vehicle controller 110 or server 300.

Regarding the firmware reprogramming performed by the BMS 122, and more specifically, the control unit 1221 of the BMS 122, the battery exchange station 200 and server 300, which are other components of the system of the present disclosure, are first described, and then description continues.

The battery exchange station 200 (battery swapping station (BSS)) is a station equipped with facilities to charge the battery of an electric vehicle, and may be referred to as an exchange station in the sense that it is a place where the driver of the electric vehicle exchanges his or her discharged battery with a charged battery. Alternatively, it may be referred to as a charging station in the sense that it is a place to charge the discharged battery left behind by the operator of the electric vehicle.

The battery exchange station 200 may include a control unit 210, a communication unit 220, a memory unit 230, an input/output (I/O) unit 240, and a battery slot unit 250.

The control unit 210 may control each component of the battery exchange station 200. The control unit 210 may be any of various controllers that may perform operations by executing computer program instructions, such as a CPU, MCU, microcontroller, or microprocessor.

For example, the control unit 210 may function as a communication module together with the communication unit 220 to control transmission and reception of information to and from the server 300. The communication unit 220 is a component that may communicate with other components via wired and/or wirelessly.

Alternatively, for example, the control unit 210 may function as a memory module together with the memory unit 230 and control to load data stored in the memory unit 230 or store new data. The memory unit 230 may include volatile memory and non-volatile memory. For example, it may be at least one of various storage media such as semiconductor memory such as RAM, ROM, and flash memory, magnetic disk, and optical disk. The memory unit 230 may be built into the control unit 210 or may be installed separately from the control unit 210.

Alternatively, for example, the control unit 210 may function as an input/output module together with the input/output unit 240 to control input and output of data. The input/output module may perform input/output of various input signals and output signals. For example, the input/output unit 240 may be configured to include an input/output interface (not shown) and receive input from a user. Alternatively, the input/output unit 240 may further include an output interface (not shown) such as a display for displaying information.

Alternatively, for example, the control unit 210 may function as a charging module together with a battery slot unit 250. The battery slot unit 250 may include a plurality of battery slots. The battery slot may refer to a space where the battery pack 120 is inserted to charge the battery pack 120 separated from the electric vehicle. The control unit 210 may detect that the discharged battery pack 120 is inserted into the battery slot and control an electrical connection between the battery slot unit 250 and the discharged battery pack 120 so that power is supplied to the discharged battery pack 120. To this end, the battery slot unit 250 may further include components such as a converter that converts external power into battery charging power and a switch that turns on and off charging of the battery.

When the battery pack 120 is inserted into the battery slot 250 of the battery exchange station 200, the server 300 may transmit the firmware of each of the part controllers 130 to the BMS 122 of the battery pack 120.

The server 300 may include a control unit 310, a communication unit 320, a memory unit 330, and an input/output (I/O) unit 340.

The control unit 310 may control each configuration of the server 300. The control unit 310 may be any of various controllers that may perform operations by executing computer program instructions, such as a CPU, MCU, microcontroller, or microprocessor.

For example, the control unit 310 may function as a communication module together with the communication unit 320 to communicate with the battery exchange station 200 or communicate with the BMS 122 inserted into the battery slot to control transmission and reception of information.

Alternatively, for example, the control unit 310 may function as a memory module together with the memory unit 330 and control to load data stored in the memory unit 330 or store new data. The memory unit 330 may include volatile memory and non-volatile memory. For example, it may be at least one of various storage media such as semiconductor memory such as RAM, ROM, and flash memory, magnetic disk, and optical disk. The memory unit 330 may be built into the control unit 310 or may be installed separately from the control unit 310. The memory unit 330 may store the latest version of firmware and firmware version information. The latest version of firmware may be uploaded by an administrator.

Alternatively, for example, the control unit 310 may function as an input/output module together with the input/output unit 340 to control input and output of data. The input/output module may perform input/output of various input signals and output signals. For example, the input/output unit 340 may be configured to include an input/output interface (not shown) and to receive input from the user. Alternatively, the input/output unit 340 may further include an output interface (not shown) such as a display for displaying information.

Meanwhile, the server 300 may be configured to operate based on cloud hosting.

Hereinafter, an embodiment of the system of the present disclosure for reprogramming the firmware of a plurality of part controllers installed inside a vehicle using the BMS of the battery pack as a medium will be described in detail.

### 1. Download of the Latest Firmware

A user of an electric vehicle may visit the battery exchange station 200 when the battery pack 120 is discharged below a predetermined level while driving the electric vehicle. The user may remove the discharged battery pack 120 from his vehicle 100 and insert the discharged battery pack into the battery slot of the battery exchange station 200 to charge the battery pack, and then, withdraws a new battery pack that is waiting in a fully charged state from another battery slot, and install the new battery pack in his or her vehicle, and then leaves the battery exchange station 200.

In this case, power is supplied to the discharged battery pack 120 inserted into the battery slot and charging begins, and at the same time, the server 300 and the BMS 122 perform communication.

The server 300 stores the latest version of firmware and the version information of the firmware. The BMS 122 stores firmware version information of the part controllers 130 of the vehicle 100 on which it has been installed.

The BMS 122 may compare the version information of the firmware of each of the part controllers 130 being stored with the version information of the firmware stored in the server 300.

As a result of the comparison, if the version information of the firmware stored in the server 300 is a firmware version that is more recent than the version information of the firmware of each of the part controllers 130, the BMS 122 may download the stored firmware and store the same in the memory unit 1223. In this case, the version information of the downloaded firmware may be updated.

For example, if the firmware version information of the motor controller stored in the BMS 122 is 1.1 and the firmware version information of the motor controller stored in the server 300 is 1.2, since the firmware version information of the motor controller stored in the server 300 is a more recent version, the BMS 122 may download the firmware of the motor controller from the server 300. Once the download is complete, the BMS 122 may update the firmware version information of the motor controller it stores to version 1.2.

When the battery pack 120, whose firmware has been downloaded, is fully charged, it is mounted in the battery slot and is on standby until a new user withdraws it.

If the version information of all part controllers 130 is the latest version compared to the version information of the firmware stored in the server 300, the firmware download is not performed and only charging of the battery pack 120 is performed. Once the charging is completed, it is mounted in the battery slot and is on standby until a new user withdraws it.

Meanwhile, when the battery pack 120 is mounted in the battery slot and is on standby, the latest version of the firmware stored in the server 300 may be changed. As such, if there is firmware in the server 300 whose version information has changed, a download command message may be sent from the server 300 to the BMS 122 so that the latest version of the firmware may be downloaded again.

Alternatively, the BMS 122 and server 300 may re-compare each other's firmware version information at preset intervals so that the latest version of the firmware may be downloaded again.

Alternatively, transmission of the above-described download command and comparison of version information at regular intervals may be implemented simultaneously.

In this way, by sending a download command when a change in version information occurs and/or comparing the version information of the firmware at regular intervals, even when the battery pack 120 is installed in the battery slot and stands for a long time, there is an advantage in that the latest version of the firmware may always be downloaded and stored.

Meanwhile, here, an embodiment in which the server 300 and BMS 122 are configured to directly communicate to download firmware has been described, but an embodiment may be configured such that the server 300 and battery exchange station 200 communicate, the battery exchange station 200 downloads and stores the latest firmware in its memory unit 230, and then, if the battery pack 120 is installed in the battery slot, the firmware stored by the battery exchange station 200 is downloaded to the BMS 122.

### 2. Reprogramming of Part Controllers

The battery pack 120 that has been standby in the battery slot after downloading and charging the latest firmware may be separated from the battery slot at the user's choice and installed in the user's vehicle 100.

When the battery pack 120 is mounted on the vehicle 100, the BMS 122 may communicate with the vehicle controller 110 provided in the vehicle 100 on which it is mounted.

As described above, the vehicle controller 110 communicates with the plurality of part controllers 130 provided inside the electric vehicle to receive and store firmware version information for each of the part controllers 130. Accordingly, the BMS 122 may receive and store firmware version information for each of the part controllers 130 provided in the electric vehicle through communication with the vehicle controller 110. In this case, the BMS 122 may receive and store the firmware version information of the vehicle controller 110 along with the firmware version information of each of the part controllers 130.

Meanwhile, the current firmware version information of each of the part controllers 130 received from the vehicle controller 110 and the current firmware version information of the vehicle controller 110 are referred to as first version information for convenience. When mounted on the battery exchange station 200, the version information of the latest firmware that is downloaded and stored from the server 300 is referred to as second version information for convenience.

The BMS 122 may compare the first version information and the second version information.

Meanwhile, communication between the BMS 122 and the vehicle controller 110 may be performed whenever the vehicle is started while the battery pack 120 is mounted on the electric vehicle. That is, the reception of firmware version information by the BMS 122 from the vehicle controller 110 and the above comparison may always be performed immediately after the engine is turned on.

As a result of the comparison, if there is a controller in which the second version information is more recent than the first version information among the plurality of part controllers 130 and vehicle controller 110, the BMS 122 reprograms the firmware of the corresponding controller.

In this case, the vehicle controller 110 has already received the current version information from the part controllers 130 before the battery pack 120 is installed, and when the battery pack 120 is installed, the BMS 122 first communicates with the vehicle controller 110 to compare version information, and performs reprogramming by communicating only with controllers that are not the latest version, according to the comparison result.

Through this, the occupancy rate of a CAN bus may be minimized, thereby reducing the load on a communication network.

In addition, hereinafter, for convenience of explanation, the corresponding controller is referred to as a reprogramming target controller. The controller to be reprogrammed may be the vehicle controller 110.

Meanwhile, operation of the electric vehicle may be prohibited until firmware reprogramming of the controller to be reprogrammed is completed. More specifically, when the BMS 122 notifies the vehicle controller 110 through communication that a controller to be reprogrammed exists according to the above comparison of the BMS 122, the vehicle controller 110 may prohibit operation of the electric vehicle. In this case, prohibition of driving may be achieved, for example, by the vehicle controller 110 controlling power not to be supplied from the battery pack 120 to a driving motor (not shown). That is, when the vehicle controller 110 sends a driving prohibition command to the motor controller, the driving prohibition may be implemented in such a way that the motor controller generates a signal to block the connection between the battery pack 120 and the driving motor. However, the implementation of driving prohibition is not limited to the above-described example, and other common techniques that only restrict the operation of the driving motor while the engine is running may be employed.

Through this, the operation of the electric vehicle is restricted until the reprogramming of the firmware is completed, so that the controllers may always be updated to the latest state before driving the vehicle 100, thereby ensuring the safety of vehicle operation.

Meanwhile, as a possible embodiment, the prohibition of the operation of the electric vehicle may be performed only in the case, for example, where reprogramming is required for the components directly related to the operation of the vehicle 100, such as the vehicle controller 110 and the motor controller (not shown), that is, a controller that performs control of transmitting power to the driving motor of the vehicle 100 or a controller that performs integrated control of vehicle parts. Since air conditioning parts, instrument panels, etc. may not be considered parts directly related to the operation of the vehicle 100, if only reprogramming of the controller of the corresponding part is required, the operation of the electric vehicle is not prohibited, and vehicle operation and reprogramming may be implemented simultaneously.

Through this, user inconvenience caused by operation restrictions due to reprogramming may be minimized.

Meanwhile, as a possible embodiment, the BMS 122 may transmit a reprogramming performance notification to the user of the electric vehicle when a controller to be reprogrammed exists. The notification may be displayed as a warning text or warning light in a cluster.

The BMS 122 may perform reprogramming by first receiving the user's selection of whether to perform reprogramming based on the notification. In this case, the reprogramming and driving prohibition may proceed only when the user selects to perform reprogramming. The selection may be input through a cluster or a separate interface.

Alternatively, the BMS 122 may provide the notification as a simple guide window while performing reprogramming, rather than to receive input of the user's selection.

The BMS 122 may reprogram the controller to be reprogrammed with firmware having second version information. More specifically, the control unit 1221 of the BMS 122 may transmit a CAN message according to the reprogramming sequence to allow the firmware of the controller to be reprogrammed to be reprogrammed. Here, the reprogramming sequence may include a reprogramming mode entry command, a checksum check, a block-by-block message transmission and cyclic redundancy check (CRC) check, a termination, and a normal mode conversion command.

After reprogramming is completed, the BMS 122 may communicate with the vehicle controller 110 to update firmware version information of the controller to be reprogrammed. That is, the vehicle controller 110 is updated with the current version information of the part controllers for which reprogramming has been completed. In other words, the first version information is updated to the second version information.

Through this, in the case of the next ignition on while the same battery pack 120 is still installed in the vehicle 100, the version information is the same even if the BMS 122 and vehicle controller 110 compare the version information with each other. Therefore, reprogramming is not performed.

Accordingly, repetitive and overlapping reprogramming may be prevented through the update.

After reprogramming is completed, the BMS 122 may release the prohibition on driving the electric vehicle. The release of the operation prohibition may be performed, for example, by controlling, by the vehicle controller 110, the connection of the power supply from the battery pack 120 to the driving motor when the BMS 122 sends a reprogramming completion message to the vehicle controller 110,

Meanwhile, when comparing the above version information, there may be a controller in which the first version information is a more recent version than the second version information. This means that when the battery pack 120 has been mounted on the battery exchange station 200, the latest version of the firmware has not been downloaded properly.

In this case, as a possible embodiment, the BMS 122 may store reprogramming error information in the memory unit 1223. In this case, reprogramming is not performed. The BMS 122 may later transmit the stored error information to the server 300 when the battery pack 120 is mounted on the battery exchange station 300.

When the server 300 receives the error information from the BMS 122, the server 300 may provide a notification that a malfunction diagnosis of the battery pack 120 is necessary to the manager of the battery exchange station 200 or manager of a company related to the battery supply business. Through this, the manager has the advantage of being able to easily manage the BMS 122 of the battery pack 120 to function normally.

Alternatively, as a possible embodiment, the BMS 122 may receive and store a more recent version of the firmware of the controller. More specifically, rather than reprogramming the firmware from the BMS 122 to the controller, the firmware of the controller with a more recent version of the firmware may be uploaded to the BMS 122. In this case, the second version information stored in the BMS 122 may be updated with the first version information.

Alternatively, as a possible embodiment, the BMS 122 may upload a more recent version of the firmware of the controller and store error information at the same time.

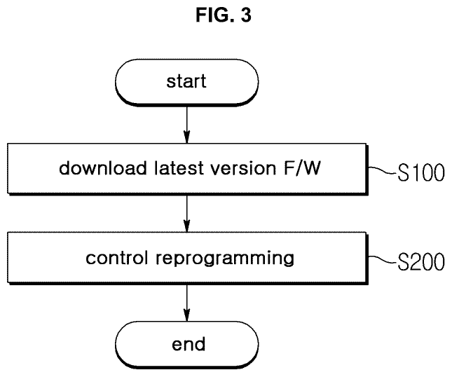

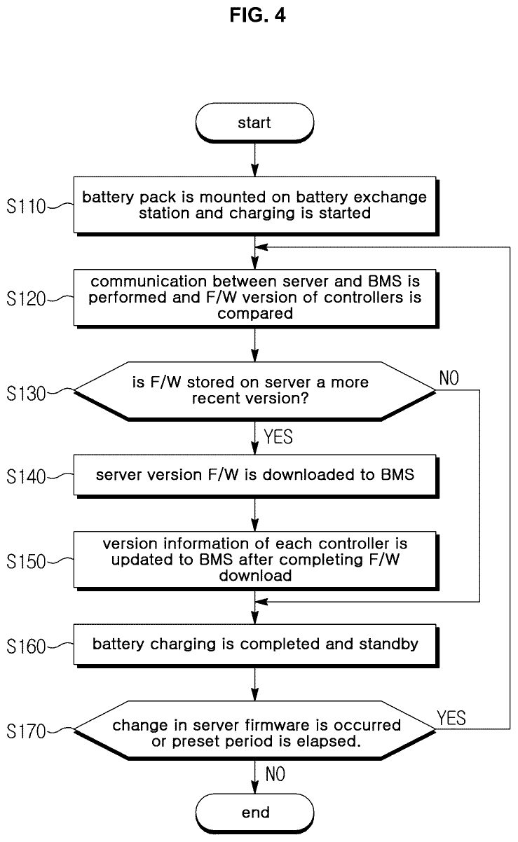

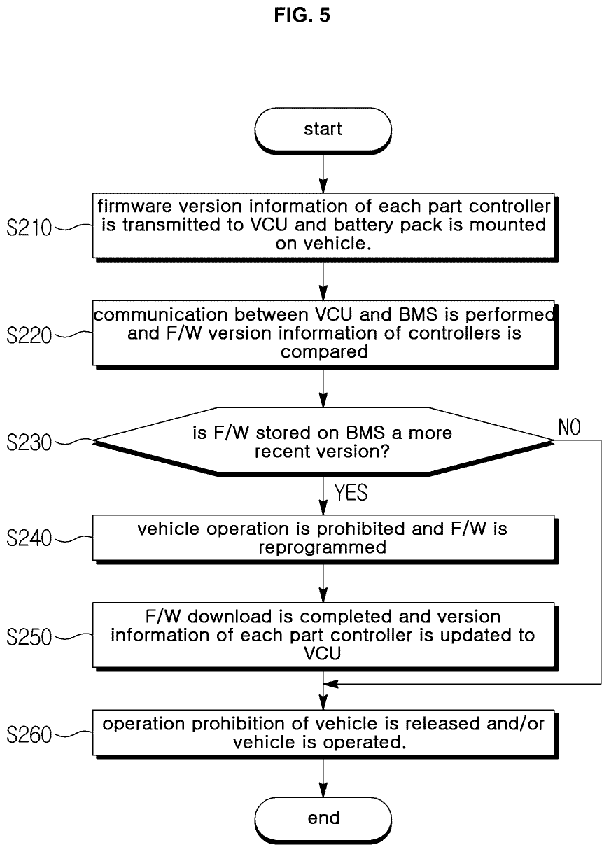

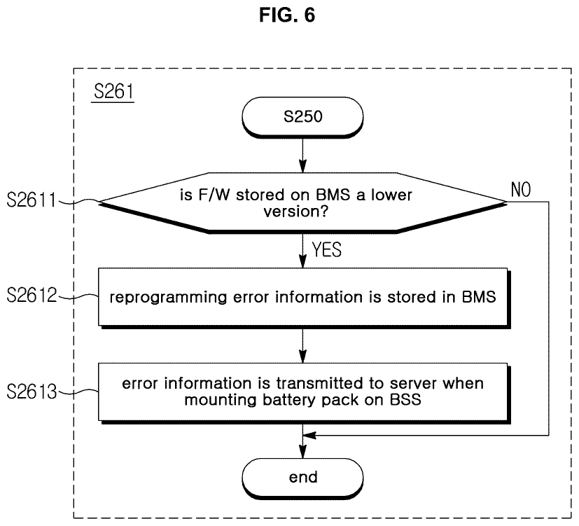

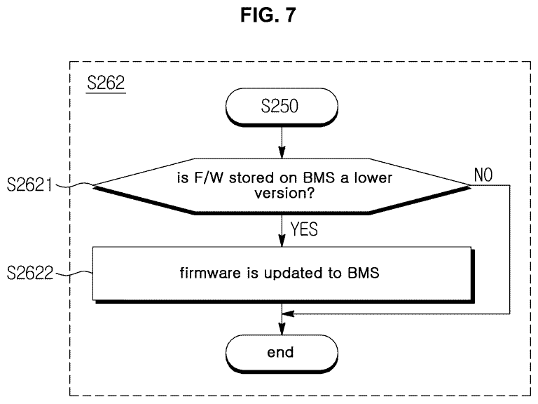

FIG. 3 is a flowchart showing a flow of a firmware reprogramming method according to an embodiment of the present disclosure, FIG. 4 is a flowchart showing a detailed flow of a latest version firmware download step in FIG. 3, FIG. 5 is a flowchart showing a detailed flow of a controller reprogramming step in FIG. 3, FIG. 6 shows a detailed flow of a possible embodiment of a vehicle driving prohibition release step in FIG. 5, FIG. 7 shows a detailed flow of another possible embodiment of a vehicle driving prohibition release step in FIG. 5.

Referring to FIGS. 3 to 7, the firmware reprogramming method according to an embodiment of the present disclosure may be performed by a firmware reprogramming system 1000 previously described with reference to FIGS. 1 to 2, and include a latest version firmware download step (S100) and a controller reprogramming step (S200).

In the latest version firmware download step (S100), when the battery pack 120 of the electric vehicle is mounted in the battery slot of the battery exchange station 200, the BMS 122 provided in the battery pack 120 downloads the latest version firmware stored in the server 300.

More specifically, this step (S100) may proceed including the following steps.

When the battery pack 120 is mounted in the battery slot of the battery exchange station 200, the battery pack 120 begins to charge (S110).

The BMS 122 provided in the battery pack 120 compares the firmware version information of each part controller 130 that it stores with the firmware version information stored in the server 300 (S120).

As a result of the comparison, if there is a firmware version in which the version information of the firmware stored in the server 300 is more recent than the version information of the firmware of each of the part controllers 130, the latest version of the firmware stored in the server 300 is downloaded and stored (S130, S140).

When the download is completed, the firmware version information of each controller stored in the BMS 122 is updated (S150).

In step S130, if all firmware of the respective part controllers 130 stored in the BMS 122 is the latest version, only battery charging is performed, and after charging is completed, the battery pack 120 stands by in the battery slot (S130, S160).

Alternatively, when reprogramming is completed, the fully charged battery pack 120 is on standby in the battery slot (S160).

Meanwhile, in this case, if a change occurs in the version information of the firmware stored in the server 300 or if a preset period elapses after the battery pack 120 is mounted in the battery slot, the step return to step S120 and the step is performed again starting from the comparison of version information.

Next, in the controller reprogramming step (S200), when the battery pack 120 that has completed charging at the battery exchange station 200 is mounted on the electric vehicle, the BMS 122 reprogram the firmware of the plurality of part controllers 130 provided inside the electric vehicle or the firmware of the vehicle controller 110.

More specifically, this step (S200) may proceed including the following steps.

The part controllers 130 provided inside the vehicle 100 communicate with the vehicle controller 110, and through this, the firmware version information of each of the part controllers 130 is transmitted and stored in the vehicle controller 110. Thereafter, the battery pack 120 separated from the battery slot of the battery exchange station 200 is mounted on the vehicle 100 (S210).

When the battery pack 120 is mounted on the electric vehicle, the BMS 122 provided in the battery pack 120 communicates with the vehicle controller 110 to receive and store version information of the firmware of each of the part controllers 130. Thereafter, the first version information, which is the firmware version information received from the vehicle controller 110, is compared with the second version information downloaded from the server 300 and stored in the BMS 122 (S220).

As a result of the comparison, if there is a controller to be reprogrammed in which the second version information is more recent than the first version information, the BMS 122 prohibits operation of the electric vehicle and reprogram the controller to be reprogrammed with firmware having the second version information (S230, S240).

Meanwhile, if a controller to be reprogrammed exists, a reprogramming performance notification may be transmitted to the user of the electric vehicle.

When reprogramming of the controller to be reprogrammed is completed, the BMS 122 may communicate with the vehicle controller 110 to update the firmware version information of the controller to be reprogrammed (S250).

Thereafter, the operation prohibition of the electric vehicle may be released and/or the electric vehicle may be driven (S260).

Meanwhile, when comparing the version information, there may be a controller in which the first version information is a more recent version than the second version information. This means that when the battery pack 120 has been mounted on the battery exchange station 200, the latest version of the firmware has not been downloaded properly.

In this case, FIG. 6 shows a possible embodiment (S261) of step S260.

The BMS 122 may determine whether the second version information is a lower version than the first version information (S2611) and, if the first version information is a lower version, the BMS may store reprogramming error information in the memory unit 1223 (S2612). In this case, reprogramming is not performed. The BMS 122 may later transmit the stored error information to the server 300 after the battery pack 120 is mounted on the battery exchange station 200 (S2613).

FIG. 7 shows another possible embodiment (S262) of step S260.

The BMS 122 determines whether the second version information is a lower version than the first version information (S2621). If the first version information is a lower version, the BMS 122 may receive and store the firmware of the controller that is the latest version (S2622). More specifically, rather than reprogramming the firmware from the BMS 122 to the controller, the firmware of the controller with a more recent version of the firmware may be uploaded to the BMS 122. In this case, the second version information stored in the BMS 122 may be updated with the first version information.

Alternatively, as a possible embodiment not shown, the BMS 122 may upload a more recent version of the firmware of the controller and store error information at the same time.

Meanwhile, a more detailed description of the firmware reprogramming method according to an embodiment of the present disclosure may be replaced with a description of the firmware reprogramming system 1000 described above.

As described above, according to the present disclosure, through the battery management system provided in the battery pack, when the battery pack is mounted in the slot of the battery exchange station and being charged, the latest version of firmware is downloaded from the server, and when the charging of the battery pack is completed and the battery pack is mounted in the vehicle, it is configured to reprogram the firmware of the controllers of the vehicle equipped with the battery pack to the latest version. Therefore, automatic reprogramming of the controller is possible without any separate device, equipment, or user action.

As a result, first, the firmware of all vehicles using the battery exchange station can be maintained at the latest version, so vehicle recalls due to firmware can be prevented.

Second, the degree of freedom in layout when manufacturing a vehicle can be increased.

Meanwhile, although the present disclosure has been described with specific embodiments and drawings, the present disclosure is not limited to the above embodiments, and various modifications and changes may be made by those skilled in the art from these descriptions. Therefore, the technical idea of the present disclosure should be understood only by the claims, and all equivalent or equivalent modifications thereof shall fall within the scope of the technical idea of the present disclosure.

What is claimed is:

1. A battery exchange station-based firmware reprogramming system, comprising:
a vehicle controller which communicates with a plurality of part controllers provided inside an electric vehicle so as to receive and store version information of firmware of each of the part controllers;
a battery management system provided in a battery pack of the electric vehicle;
a battery exchange station including a plurality of slots so as to charge the battery pack separated from the electric vehicle; and
a server which transmits the firmware of each of the part controllers to the battery management system when the battery pack is inserted into one of the slots,
wherein when the battery pack is mounted in the electric vehicle, the battery management system communicates with the vehicle controller to receive, store, and update version information of the firmware of each of the part controllers.

2. The system of claim 1, wherein when the battery pack is installed in the electric vehicle, the battery management system compares first version information received from the vehicle controller with second version information downloaded and stored from the server.

3. The system of claim 2, wherein as a result of the comparison, if there is a controller to be reprogrammed in which the second version information is more recent than the first version information, among the plurality of part controllers and the vehicle controller, the battery management system prohibits operation of the electric vehicle and reprograms the controller to be reprogrammed with firmware having the second version information.

4. The system of claim 3, wherein after the reprogramming is completed, the battery management system updates the firmware version information of the controller to be reprogrammed to the vehicle controller and releases the operation prohibition of the electric vehicle.

5. The system of claim 2, wherein as a result of the comparison, if there is a controller to be reprogrammed in which the second version information is a more recent version than the first version information, among the plurality of part controllers and the vehicle controller, the battery management system transmits reprogramming performance notification to a user of the electric vehicle.

6. The system of claim 2, wherein as a result of the comparison, if there is a controller to be reprogrammed in which the first version information is a more recent version than the second version information, among the plurality of part controllers and the vehicle controller, the battery management system stores reprogramming error information and transmits the error information to the server after being mounted on the battery exchange station.

7. The system of claim 2, wherein as a result of the comparison, if there is a controller to be reprogrammed in which the first version information is a more recent version than the second version information, among the plurality of part controllers and the vehicle controller, the battery management system receives and stores the firmware of the controller, which is the latest version.

8. The system of claim 1, wherein when the battery pack is mounted in the slot, the battery management system compares the version information of the firmware of each of the part controllers being stored with the version information of the firmware stored in the server.

9. The system of claim 8, wherein as a result of the comparison, if there is firmware in which the version information of the firmware stored in the server is more recent than the version information of the firmware of each of the part controllers, the battery management system downloads and stores the firmware stored in the server, and updates the version information of the downloaded firmware.

10. The system of claim 8, wherein in a state in which the battery pack is mounted in the slot of the battery exchange station, if firmware whose version information has changed exists in the server, or if a preset period has elapsed, the battery management system performs the comparison again.

11. A battery exchange station-based firmware reprogramming method, comprising the steps of:
downloading, by a battery management system provided in a battery pack, a latest version of firmware stored in a server when the battery pack of an electric vehicle is mounted in a slot of the battery exchange station; and
reprogramming, by the battery management system, firmware of a plurality of part controllers provided inside the electric vehicle or firmware of a vehicle controller when the battery pack that has completed charging at the battery exchange station is mounted on the electric vehicle,
wherein in the step of reprogramming the firmware, when the battery pack is mounted in the electric vehicle, the battery management system communicates with the vehicle controller to receive, store, and update version information of the firmware of each of the part controllers.

12. The firmware reprogramming method of claim 11, wherein in the step of reprogramming the firmware, when the battery pack is installed in the electric vehicle, first version information received from the vehicle controller is compared with second version information downloaded and stored from the server,
wherein as a result of the comparison, if there is a controller to be reprogrammed in which the second version information is more recent than the first version information, among the plurality of part controllers and the vehicle controller, operation of the electric vehicle is prohibited and the controller to be reprogrammed is reprogrammed with firmware having the second version information.

13. The firmware reprogramming method of claim 12, wherein in the step of reprogramming the firmware, after the reprogramming is completed, the firmware version information of the controller to be reprogrammed is updated to the vehicle controller and the operation prohibition of the electric vehicle is released.

14. The firmware reprogramming method of claim 11, wherein in the step of reprogramming the firmware, when the battery pack is installed in the electric vehicle, first version information received from the vehicle controller is compared with second version information downloaded and stored from the server,
wherein, as a result of the comparison, if there is a controller to be reprogrammed in which the second version information is a more recent version than the first version information, among the plurality of part controllers and the vehicle controller, reprogramming performance notification is transmitted to a user of the electric vehicle.

15. The firmware reprogramming method of claim 11, wherein in the step of reprogramming the firmware, when the battery pack is installed in the electric vehicle, first version information received from the vehicle controller is compared with second version information downloaded and stored from the server,
wherein as a result of the comparison, if there is a controller to be reprogrammed in which the first version information is a more recent version than the second version information, among the plurality of part controllers and the vehicle controller, reprogramming error information is stored and the error information is transmitted to the server after being mounted on the battery exchange station.

16. The firmware reprogramming method of claim 11, wherein in the step of reprogramming the firmware, when the battery pack is installed in the electric vehicle, first version information received from the vehicle controller is compared with second version information downloaded and stored from the server,
wherein as a result of the comparison, if there is a controller to be reprogrammed in which the first version information is a more recent version than the second version information, among the plurality of part controllers and the vehicle controller, the firmware of the controller, which is the latest version, is transmitted and stored.

17. The firmware reprogramming method of claim 11, wherein in the step of downloading the latest version of firmware, when the battery pack is mounted in the slot, the version information of the firmware of each of the part controllers being stored is compared with the version information of the firmware stored in the server,
wherein as a result of the comparison, if there is firmware in which the version information of the firmware stored in the server is more recent than the version information of the firmware of each of the part controllers, the firmware stored in the server is downloaded and stored, and the version information of the downloaded firmware is updated.

18. The firmware reprogramming method of claim 17, wherein in the step of downloading the latest version of firmware, in a state in which the battery pack is mounted in the slot of the battery exchange station, if firmware whose version information has changed exists in the server, or if a preset period has elapsed, the comparison is performed again.
